(19) United States
(12) Patent Application Publication
(10) Pub. No.: US 2025/0201443 A1
(43) Pub. Date: Jun. 19, 2025

(54) COVERED ELECTRIC WIRE AND WIRING HARNESS

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Hayato OOI, Yokkaichi-shi (JP); Kyoma SAHASHI, Yokkaichi-shi (JP); Koki SUMIDA, Yokkaichi-shi (JP); Toyoki FURUKAWA, Yokkaichi-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 18/843,397

(22) PCT Filed: Mar. 16, 2023
(86) PCT No.: PCT/JP2023/010352

§ 371 Date: Sep. 3, 2024

(30) Foreign Application Priority Data
Mar. 24, 2022 (JP) 2022-048058

(51) Int. Cl. H01B 7/08; H01B 7/00

(52) U.S. Cl. CPC H01B 7/08; H01B 7/0045

(57) ABSTRACT

A covered electric wire includes a conductor including a plurality of elemental wires and an insulation covering. The covered electric wire contains a flat portion. The covered electric wire has the following features in the cross-section of the flat portion. The covered electric wire has an out-of-conductor vacancy provided as a vacancy between the conductor and insulation covering. When the cross-section is divided into four equal parts in the width direction and two equal parts in a height direction perpendicular to the width direction to form eight divided regions, an area of the out-of-conductor vacancy in each of four corner divided regions, located at corners, among the eight divided regions accounts for less than 20% of a total area of the vacancy in the cross-section. The insulation covering has no portion intruding into the conductor at a depth more than half of the outer diameter of the elemental wires.

### TECHNICAL FIELD

The present disclosure relates to a covered electric wire and a wiring harness.

### BACKGROUND ART

Flat cables including flat-shaped conductors are known. A flat cable can occupy a smaller space for installation than a generally used electric wire including a conductor having an approximately circular cross-section.

A conventional flat cable often includes a flat rectangular conductor, as disclosed in Patent Documents 1 and 2. A flat rectangular conductor is a single metal wire formed to have a rectangular cross-section. Patent Documents 3 to 5, filed by the present applicants, each disclose a conductor that is formed as a stranded wire including a plurality of elemental wires twisted together and has a flat portion having a flat shape in the cross-section intersecting the axial direction of the stranded wire, from the viewpoint of achieving both flexibility and space-saving.

### CITATION LIST

### Patent Literature

Patent Document 1: JP 2014-130739 A
Patent Document 2: JP 2019-149242 A
Patent Document 3: WO 2019/093309 A1
Patent Document 4: WO 2019/093310 A1
Patent Document 5: WO 2021/200937 A1

### SUMMARY OF INVENTION

### Technical Problem

When an insulation covering is formed on the outer circumference of a flat-shaped conductor to make a covered electric wire, the contact area between the conductor and the insulation covering is larger than in the case of a conventional conductor with a circular cross-section having the same cross-sectional area. As a result, the adhesion of the insulation covering to the flat-shaped conductor is likely to be greater. The greater adhesion may cause difficulty in completely removing the insulation covering in a desired region, such as at the end of a covered electric wire. If a part of the insulation covering can not be removed and remains, problems may occur, such as an inability to form an electrical connection properly between the conductor and a terminal connected to the end of the wire. Though it is possible to reduce the adhesion between the insulation covering and the conductor by, for example, selecting the conditions for forming the insulation covering through extrusion molding, the reduction of the adhesion would reduce the flame retardancy of the covered electric wire by hindering heat dissipation from the insulation covering to the conductor.

In view of the above, the objective is to provide a covered electric wire with a conductor having a flat cross-section that excels in both flame retardancy and ease of removal of an insulation covering, as well as to provide a wiring harness including such a covered electric wire.

### Solution to Problem

A covered electric wire according to the present disclosure includes a conductor including a plurality of elemental wires twisted together and an insulation covering that covers the conductor. The covered electric wire contains a flat portion in which the conductor has a flat shape elongated in a width direction in a cross-section perpendicular to an axial direction of the covered electric wire. The covered electric wire has the following features in the cross-section of the flat portion: the covered electric wire contains an out-of-conductor vacancy provided as a vacancy between the conductor and the insulation covering; when the cross-section is divided into four equal parts in the width direction and two equal parts in a height direction perpendicular to the width direction to form eight divided regions, an area of the out-of-conductor vacancy in each of four corner divided regions, located at corners, among the eight divided regions accounts for less than 20% of a total area of the vacancy in the cross-section; and the insulation covering has no portion intruding into the conductor at a depth more than half of an outer diameter of the elemental wires.

A wiring harness according to the present disclosure includes the covered electric wire.

### Advantageous Effects of Invention

The covered electric wire and wiring harness according to the present disclosure serve as a covered electric wire with a conductor having a flat cross-section that excels in both flame retardancy and ease of removal of the insulation covering, and as a wiring harness including such a covered electric wire.

### BRIEF DESCRIPTION OF DRAWINGS

FIG. 1 is a cross-sectional view showing a covered electric wire according to an embodiment of the present disclosure.

FIG. 2A is a cross-sectional view showing a covered electric wire with a larger corner vacancy ratio.

FIG. 2B is a cross-sectional view showing a covered electric wire with an insulation covering that has portions intruding into the conductor.

FIGS. 3A to 3E are photographs of the cross-sections of covered electric wires of Samples 1 to 5, having different states of insulation coverings.

### DESCRIPTION OF EMBODIMENTS

### Description of Embodiments of Present Disclosure

First, embodiments of the present disclosure will be explained.

A covered electric wire according to the present disclosure includes a conductor including a plurality of elemental wires twisted together and an insulation covering that covers the conductor. The covered electric wire contains a flat portion in which the conductor has a flat shape elongated in a width direction in a cross-section perpendicular to an axial direction of the covered electric wire. The covered electric wire has the following features in the cross-section of the flat portion: the covered electric wire contains an out-of-conductor vacancy provided as a vacancy between the conductor and the insulation covering; when the cross-section is divided into four equal parts in the width direction and two equal parts in a height direction perpendicular to the width direction to form eight divided regions, an area of the out-of-conductor vacancy in each of four corner divided regions, located at corners, among the eight divided regions accounts for less than 20% of a total area of the vacancy in the cross-section; and the insulation covering has no portion intruding into the conductor at a depth more than half of an outer diameter of the elemental wires.

In the cross-section of the flat portion of the above-mentioned covered electric wire, the area of the out-of-conductor vacancy in each of the four corner divided regions is limited to less than 20% of the total area of the vacancy. Thus, high proximity of the insulation covering to the conductor is ensured at the corners of the covered electric wire. When an insulation covering is formed on the outer circumference of a flat-shaped conductor through extrusion molding, the thickness of the insulation covering tends to be larger at the corners of the flat-shaped covered electric wire than at other portions, making heat dissipation from the insulation covering to the conductor less efficient at the corners. However, the ensured high proximity of the insulation covering to the conductor at the corners improves the flame retardancy of the wire through heat dissipation from the insulation covering to the conductor. Meanwhile, since the insulation covering has no portion intruding into the conductor at a depth more than half of the outer diameter of the elemental wires, the adhesion of the insulation covering to the conductor is not excessively great, which allows easy removal of the insulation covering at, for example, the end of the covered electric wire.

Here, it is preferable that the conductor has a flatness ratio of 5 or less in the cross-section of the flat portion, where the flatness ratio is evaluated as w/h, with w and h representing the lengths of the conductor along the width and height directions, respectively. In this case, the corners occupy a large portion of the entire circumference of the conductor in the cross-section of the flat portion and have a significant relative influence on the flame retardancy. Thus, the effect of improving flame retardancy by limiting the area of the out-of-conductor vacancy in each of the corner divided regions to less than 20% of the total area is made particularly significant.

It is preferable that in the cross-section of the flat portion, the area of the out-of-conductor vacancy in each of the four corner divided regions accounts for 5% or more of the total area of the vacancy in the cross-section. This feature effectively improves the ease of removal of the insulation covering by limiting the proximity of the insulation covering to the conductor within an adequate range.

It is preferable that in the cross-section of the flat portion, the out-of-conductor vacancy is distributed over entire areas between the conductor and the insulation covering in four divided regions other than the corner divided regions among the eight divided regions. This feature particularly improves the ease of removal of the insulation covering. Thus, when the insulation covering is intended to be removed in a certain region, such as at the end of a covered electric wire, the insulation covering is less likely to remain unremoved.

A wiring harness according to the present disclosure includes the covered electric wire according to the present disclosure. As described above, in the cross-section of the flat portion of the covered electric wire according to the present disclosure, the area of the out-of-conductor vacancy in each of the corner divided regions is limited to less than 20% of the total area of the vacancy, and the insulation covering has no portion intruding into the conductor at a depth more than half of the outer diameter of the elemental wires. Thus, the covered electric wire excels in both flame retardancy and ease of removal of the insulation covering. By including the covered electric wire, the wiring harness can also take advantage of the high flame retardancy and ease of removal of the insulation covering of the covered electric wire.

### Detailed Description of Embodiments of Present Disclosure

A detailed description of a covered electric wire and a wiring harness according to embodiments of the present disclosure will now be provided, referring to the drawings. In the present specification, the terms indicating the shapes and arrangements of members, such as “straight”, “parallel”, and “perpendicular”, regarding parts of the covered electric wire, include deviations from geometric concepts within an acceptable range for this type of covered electric wire, such as approximately ±15% in length and approximately ±15° in angle. In the present specification, the cross-section of the covered electric wire or conductor refers to a cross-section perpendicular to the axial direction (i.e., longitudinal direction) thereof unless otherwise specified.

### <Outline of Covered Electric Wire>

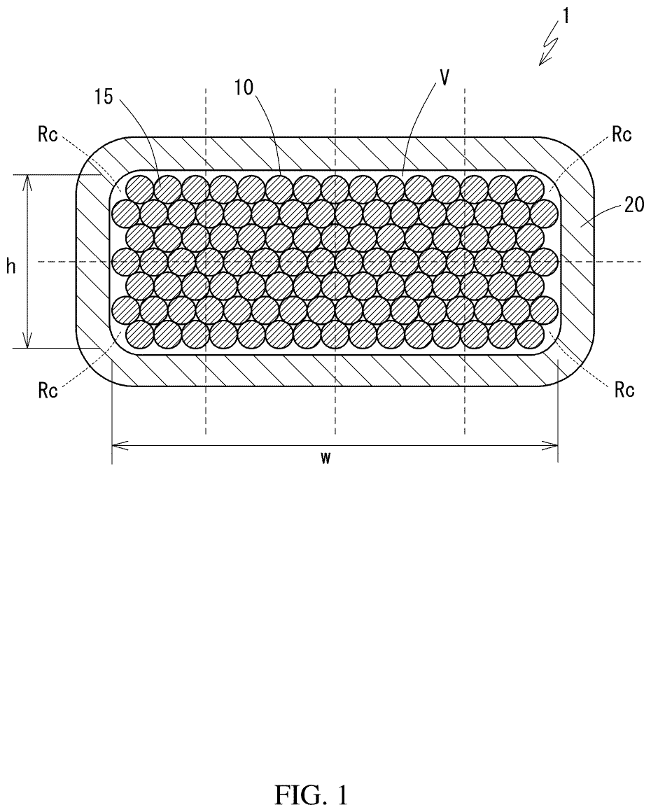

FIG. 1 shows a cross-sectional view of a covered electric wire 1 according to an embodiment of the present disclosure. The covered electric wire 1 according to the embodiment includes a conductor 10 and an insulation covering 20. The insulation covering 20 covers the conductor 10 on the entire circumference of the conductor 10.

The conductor 10 is configured as a stranded wire that includes a plurality of elemental wires 15 twisted together. The conductor 10 has a flat outer shape, at least partially along the axial direction. In other words, the conductor 10 has a flat portion with a flat shape in the cross-section. In the present embodiment, the entire region along the axial direction of the conductor 10 is configured as the flat portion. The stranded wire with the flat shape can be formed, for example, by rolling a raw stranded wire that includes a plurality of elemental wires 15 twisted together into an approximately circular cross-sectional shape.

Here, the term “flat outer shape” with respect to the conductor 10 indicates a shape where the width w is longer than the height h. The width w indicates the length of the longest straight line that crosses the cross-section of the conductor in a direction along an edge or diameter constituting the cross-section and ranges over the entire cross-section, while the height h indicates the length of the straight line that is perpendicular to the above-mentioned straight line defining the width wand ranges over the entire cross-section. The cross-section of the conductor 10 may have any specific shape as long as it is flat; examples of the flat shape include rectangles, ellipses, oblongs, oval shapes (i.e., rectangles with semicircles at both ends), parallelograms, and trapezoids. If a circumscribed shape of the cross-section can be approximated to a shape among these examples, the cross-section of the conductor 10 can be regarded as having the shape. Among the shapes listed above, it is preferable to adopt either a rectangle or an oval shape. When the cross-section of the conductor 10 can be approximated to a rectangle, it is preferable that the corners of the conductor 10, i.e., the joints between the width-direction edges and the height-direction edges, have rounded shapes (i.e., round corner shapes). The rounded shapes help to reduce the thickness of the insulation covering 20 at the corners and to increase the proximity of the insulation covering 20 to the conductor 10, thereby enhancing the effect of improving the flame retardancy of the covered electric wire 1, which will be described later.

Since the covered electric wire 1 according to the present embodiment includes the conductor 10 configured as a stranded wire with a flat cross-sectional shape, the covered electric wire 1 excels in both flexibility and space-saving. The covered electric wire 1 has particularly high flexibility and space-saving properties along the height direction of the conductor 10. The flatness ratio w/h of the conductor 10 is not specifically limited; however, the ratio should preferably be 2 or more from the viewpoint of sufficiently enhancing these effects of the flat shape. On the other hand, the flatness ratio w/h should preferably be 5 or less, and more preferably 3 or less, from the viewpoint of enhancing the effect of improving the flame retardancy of the covered electric wire 1, which will be described later.

In the conductor 10 configured as a stranded wire, at least some of the elemental wires 15 constituting the conductor 10 may have a cross-sectional shape deformed from a circular shape as a result of shaping of the conductor 10 into a flat shape. However, from the viewpoint of ensuring high flexibility of the conductor 10, it is preferable that the deformation rate of the wires 15 from a circular shape is smaller in the outer circumferential region than in the inner region in the cross-section of the conductor 10. Furthermore, it is preferable that, in the cross-section of the conductor 10, there are vacancies among the wires 15 constituting the conductor 10 that can accommodate one or more elemental wires 15, and more preferably two or more elemental wires 15.

In the covered electric wire 1, the conductor cross-sectional area is not specifically limited. However, in general, the larger the conductor cross-sectional area of a covered electric wire is, the lower the flame retardancy of the wire and the ease of removal of the insulation covering of the wire tend to be. Therefore, in the covered electric wire 1 according to the present embodiment, the relative effect of increasing the flame retardancy and ease of removal of the insulation covering 20 by specifying the state of the insulation covering 20, as described later, becomes more significant as the conductor cross-sectional area increases. From the viewpoint of sufficiently enhancing these effects, it is preferable that the conductor 10 has a relatively large conductor cross-sectional area. For example, it is preferable that the conductor cross-sectional area is 15 mm² or larger, and more preferably 50 mm² or larger, in nominal value.

The material constituting the conductor 10 is not specifically limited, and various metal materials can be applied. Representative metal materials for constituting the conductor 10 include copper, copper alloys, aluminum, and aluminum alloys. In particular, when aluminum or an aluminum alloy is used, the conductor cross-sectional area tends to be made large in order to ensure the required electrical conductivity since the conductivities of aluminum and aluminum alloys are lower than those of copper and copper alloys. The larger the conductor cross-sectional area is, the greater effect of increasing the flame retardancy and the ease of removal of the insulation covering 20 by specifying the state of the insulation covering 20 can be achieved, as mentioned above. From this viewpoint, it is preferable to use aluminum or an aluminum alloy to constitute the conductor 10.

In the covered electric wire 1 according to the present embodiment, the conductor 10 is covered with the insulation covering 20, and the conductor 10 has a flat shape. Reflecting these features, the entire covered electric wire 1, including the insulation covering 20, also has a flat shape. In the covered electric wire 1, the insulation covering 20 is in a specific state in terms of the distribution of the vacancy between the conductor 10 and the insulation covering 20 and the intrusion into the conductor 10, as explained in detail later. Reflecting these features, the covered electric wire 1 exhibits high flame retardancy and ease of removal of the insulation covering 20.

The material constituting the insulation covering 20 is not specifically limited as long as the material is an insulating material; however, it is preferable that the material is mainly composed of an organic polymer. From the viewpoint of increasing the flame retardancy of the insulation covering 20, it is preferable that the constituent material of the insulation covering 20 has flame retardancy. However, if the constituent material of the insulation covering 20 itself has extremely high flame retardancy, it is likely that sufficient flame retardancy is achieved regardless of the state of the insulation covering 20. The effect of improving the flame retardancy of the covered electric wire 1 by specifying the state of the insulation covering 20 is relatively greater when the flame retardancy of the insulation covering 20 itself is not so high. Specifically, it is not preferable to use an organic polymer with high flame retardancy, such as polyvinyl chloride (PVC), as the polymer forming the insulation covering 20. Instead, it is preferable to use an organic polymer that does not contain chlorine and does not have high flame retardancy, such as polyolefin represented by polyethylene, where flame retardancy is imparted to the organic polymer by addition of a flame retardant. Furthermore, it is preferable to use a flame retardant containing a metal compound such as a metal hydroxide, represented by magnesium hydroxide, rather than a flame retardant that imparts high flame retardancy even in a small quantity such as a bromine flame retardant.

The method of forming the insulation covering 20 is not specifically limited; however, a layer of the insulation covering 20 is formed on the outer circumference of the conductor 10 preferably through extrusion molding of a composition that contains necessary ingredients mixed together. For example, the shape of the mold used for the extrusion molding can control the distribution of the vacancy between the insulation covering 20 and the conductor 10 and the state of intrusion of the insulation covering 20 into the conductor 10.

The covered electric wire 1 according to the present embodiment may be used either alone or as a component of a wiring harness according to the present embodiment. The wiring harness according to the present embodiment includes the covered electric wire 1 according to the above-described embodiment. The wiring harness may include a plurality of the above-mentioned covered electric wires 1. The wiring harness may include other types of covered electric wires in addition to the above-mentioned covered electric wires 1. Preferably, the above-mentioned covered electric wires 1 are arranged in row(s) in the width direction and/or the height direction. In this structure, the specific arrangement of the covered electric wires 1 is not particularly limited; however, in a preferable example, the covered electric wires 1 are arranged in the width direction and fixed to a common sheet material by fusion. In this case, it is particularly preferable that the heights of the covered electric wires 1 arranged are even.

### <State of Insulation Covering>

In the covered electric wire 1 according to the present embodiment, the distribution of the vacancy between the insulation covering 20 and the conductor 10 and the state of intrusion of the insulation covering 20 into the conductor 10 are controlled to have specific features. In other words, an out-of-conductor vacancy V is provided as a vacancy between the conductor 10 and the insulation covering 20, and the out-of-conductor vacancy V is formed to limit the corner vacancy ratio described below to less than 20%. At the same time, the insulation covering 20 has no portion intruding into the conductor.

Here, the definition of the corner vacancy ratio will be explained. The out-of-conductor vacancy V refers to the vacancy distributed between the outer circumference of the conductor 10 and the insulation covering 20, but not inside the conductor 10, among the vacancies that are not occupied by the elemental wires 15 or the insulation covering 20. To specify the distribution of the out-of-conductor vacancy V, divided regions are defined. Each of the divided regions corresponds to one-eighth of the cross-section of the covered electric wire 1. In other words, as shown by dashed lines in FIG. 1, the cross-section of the covered electric wire 1 is divided into four equal parts in the width direction and two equal parts in the height direction to form eight equal-sized divided regions. Among the eight divided regions, the divided regions located at the four corners are defined as corner divided regions Rc. The out-of-conductor vacancy V contained in each of the corner divided regions Rc is defined as a corner vacancy. For each of the four corner divided regions Rc, the ratio of the area (Ac) of the corner vacancy to the total area (A) of the out-of-conductor vacancy V in the cross-section of the covered electric wire 1, i.e., the ratio to the total area of the out-of-conductor vacancy V in all the eight divided regions, is defined as the corner vacancy ratio (Ac/A×100%). In the covered electric wire 1 according to the present embodiment, the corner vacancy ratio accounts for less than 20% in each of the four corner divided regions Rc, that is, in each of the individual corner divided regions Rc.

Generally, even if a flame comes into contact with an insulation covering of a covered electric wire or the insulation covering catches fire, heat dissipation from the insulation covering to the conductor can suppress the occurrence and progression of combustion of the insulation covering, thus imparting high flame retardancy to the covered electric wire. The higher the proximity of the insulation covering to the conductor is, the more efficiently heat dissipation (i.e., heat transfer) from the insulation covering to the conductor occurs, leading to a greater effect on improving the flame retardancy. The smaller the out-of-conductor vacancy between the insulation covering and the conductor is, the higher the proximity of the insulation covering to the conductor is.

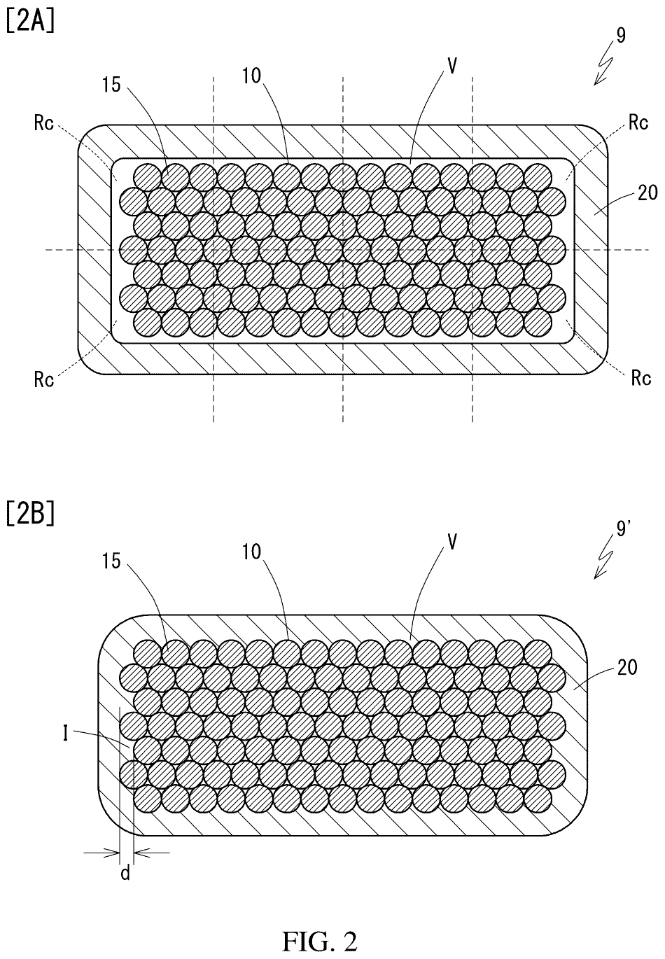

In the case of the covered electric wire including the conductor 10 with a flat cross-sectional shape, when the insulation covering 20 is formed on the outer circumference of the conductor 10 by extrusion molding or other means, the thickness of the insulation covering 20 tends to be larger at the corners of the flat shape of the cross-section than at the flat edges (i.e., the portions along the width and height directions). As a result, heat dissipation from the insulation covering 20 to the conductor 10 occurs less efficiently at the corners. In addition, the amount of flammable insulation covering 20 is larger at the corners. Consequently, the corners of the flat shape are more likely to cause a reduction in the flame retardancy compared to the edges. As described above, the higher the proximity of the insulation covering 20 to the conductor 10 is, the more efficiently heat dissipation occurs from the insulation covering 20 to the conductor 10. In contrast, if a large out-of-conductor vacancy V is present between the insulation covering 20 and the conductor 10, the proximity between the insulation covering 20 and the conductor 10 is low, and thus the heat dissipation occurs less efficiently. If a large out-of-conductor vacancy V is present at the corners of the flat shape, as in the covered electric wire 9 shown in FIG. 2A, heat dissipation from the insulation covering 20 to the conductor 10 does not occur at the corners efficiently. As a result, the corners, which tend to cause a reduction in the flame retardancy of the covered electric wire 9 due to the large thickness of the insulation covering 20 as described above, further reduce the flame retardancy.

Meanwhile, in the covered electric wire 1 according to the present embodiment, the corner vacancy ratio is limited to less than 20% in each of the four corner divided regions Rc. Thus, the out-of-conductor vacancy V between the conductor 10 and the insulation covering 20 is kept small at the corners. This feature ensures the high proximity of the insulation covering 20 to the conductor 10 at the corners. As a result, heat dissipation from the insulation covering 20 to the conductor 10 occurs efficiently at the corners, making the corners have less contribution to reduction in the flame retardancy of the covered electric wire 1. Consequently, the flame retardancy of the covered electric wire 1 as a whole can be improved compared to the case where a large out-of-conductor vacancy V is distributed at the corners.

From the viewpoint of further effectively increasing the flame retardancy of the covered electric wire 1, it is preferable that the corner vacancy ratio in each of the four corner divided regions Rc accounts for less than 17%. It is also preferable that the corner vacancy ratio in at least one of the four corner divided regions Rc accounts for less than 15%, and more preferably less than 10%. From the viewpoint of improving the flame retardancy, there is no specific lower limit for the corner vacancy ratio; however, from the viewpoint of increasing the ease of removal of the insulation covering 20, which will be explained below, it is preferable that the corner vacancy ratio in each of the four corner divided regions Rc accounts for 5% or more. It is also preferable that the corner vacancy ratio in at least one of the four corner divided regions Rc accounts for 10% or more.

The smaller the flatness ratio w/h of the conductor 10 is, the greater the relative influence on the corners to the flame retardancy of the covered electric wire 1 is, and the greater the effect of improving the flame retardancy by keeping the corner vacancy ratio small is. As described above, when the flatness ratio w/h is 5 or less, or even 3 or less, the effect of improving the flame retardancy by limiting the corner vacancy ratio in each of the four corner divided regions Rc to less than 20% is significant.

Furthermore, if the out-of-conductor vacancy V throughout the covered electric wire 1 is kept small, the flame retardancy can be improved more effectively. For example, it is preferable that the ratio of the area occupied by the out-of-conductor vacancy V within the area surrounded by the inner surface of the insulation covering 20 in the cross-section accounts for 25% or less. There is no particular lower limit for this area ratio; however, from the viewpoint of increasing the ease of removal of the insulation covering 20, described below, it is preferable that the area ratio is 5% or more.

In the cross-section of the covered electric wire 1 according to the present embodiment, in addition to limiting the corner vacancy ratio at each of the four corners to less than 20%, the insulation covering 20 has no intrusion portion I. Here, an intrusion portion I refers to a portion where the intrusion depth d of the insulation covering 20 reaches more than half of the outer diameter of the elemental wires 15, as shown in the covered electric wire 9′ in FIG. 2B. The intrusion depth d of the insulation covering 20 refers to the amount of inward protrusion of the inner surface of the insulation covering 20 compared to the portions on both sides of the protrusion, within the area where the inner surface of the insulation covering 20 is in continuous contact with the conductor 10 along the outer circumference of the conductor 10 in the cross-section of the covered electric wire.

If the insulation covering 20 has intrusion portions I as in the covered electric wire 9′ in FIG. 2B, the insulation covering 20 adheres tightly to the conductor 10 at the intrusion portions I. As a result, when the insulation covering 20 is intended to be removed in a certain region along the axial direction of the covered electric wire 9′ for a purpose such as connecting a terminal to the end of the conductor, the insulation covering can not be removed easily. Even if the insulation covering 20 can be removed easily in areas other than the intruding portions I, some portion of the insulation covering 20 may remain unremoved on the outer circumference of the conductor 10, in the intrusion portions I and the vicinities thereof. This phenomenon often causes problems such as failure to form a good electrical connection between the terminal and the conductor 10. In particular, the adhesion between the flat-shaped conductor 10 and the insulation covering 20 is greater than in the case of an electric wire with a circular cross-section having the same conductor cross-sectional area since the conductor 10 has a larger surface area due to the flat shape. The presence of the intrusion portions I tends to increase the difficulty of removing the insulation covering 20 further.

Meanwhile, in the covered electric wire 1 according to the present embodiment, the ease of removal of the insulation covering 20 is high because the insulation covering 20 does not have any intrusion portion I. In other words, the insulation covering 20 can be removed easily by peeling or other operations with a small force. When the insulation covering 20 is intended to be removed over a region of a certain length in an area such as at the end of the covered electric wire 1, the insulation covering 20 can be removed throughout the region so as not to leave any portion remaining on the outer circumference of the conductor 10. As a result, problems due to local remaining of the insulation covering 20, such as a poor connection, are less likely to occur.

From the viewpoint of further improving the ease of removal of the insulation covering 20, it is preferable that the out-of-conductor vacancy V is distributed over the entire areas on the outer circumference of the conductor 10 except the corner divided regions Rc, in the cross-section of the covered electric wire 1 (regardless of whether the out-of-conductor vacancy V is present in the corner divided regions Rc). In other words, it is preferable that the out-of-conductor vacancy V is distributed over the entire areas between the conductor 10 and the insulation covering 20 in the four divided regions other than the corner divided regions Rc among the eight divided regions. It is more preferable that the vacancy V is distributed along the entire outer circumference of the conductor 10, including the four corner divided regions Rc, except at the points where the conductor 10 and the insulation covering 20 unavoidably come into contact.

As described in the foregoing, in the cross-section of the flat portion of the covered electric wire 1 according to the present embodiment, the corner vacancy ratio is limited to less than 20%, and the insulation covering 20 has no intrusion portion I. As a result, the covered electric wire 1 excels in both flame retardancy and ease of removal of the insulation covering 20. The covered electric wire 1 according to the present embodiment can be used preferably in a vehicle such as an automobile. This is because the covered electric wire 1 can be routed in a narrow space inside the vehicle, having high flexibility and space-saving properties. Furthermore, even if a flame comes into contact with the covered electric wire 1 due, for example, to a fire in the vehicle, combustion of the insulation covering 20 and spread of the fire via the covered electric wire 1 are suppressed due to the high flame retardancy of the covered electric wire 1.

### EXAMPLE

A description of examples will now be presented. It should be noted that the present invention is not limited to the examples. Here, investigations were performed on the relationship of the state of the insulation covering in the covered electric wire to the flame retardancy and ease of removal of the insulation covering.

### [Method of Examination]

### (Preparation of Samples)

Conductors constituting electric wires were produced. First, stranded wires with circular cross-sections were prepared by twisting elemental wires made of an aluminum alloy. Then, the conductors were produced by rolling the stranded wires into flat shapes by rollers. Here, elemental wires with a diameter of 0.26 mm were used, and the cross-sectional area of the conductors was 130 mm². The flatness ratio w/h was 3.

Then, insulation coverings were formed on the outer circumferences of the prepared conductors through extrusion molding. In this process, by changing the shape of the mold used, the distribution of the out-of-conductor vacancy and the presence or absence of intrusion portions were controlled to produce Samples 1 to 5. Cross-linked polyethylene was used as the material for the insulation coverings. The thickness of the insulation coverings was 1.6 mm on average in each sample.

### (Evaluation of State of Insulation Covering)

Photographs of the cross-sections of the covered electric wires of Samples 1 to 5 were taken for evaluation of the states of the insulation coverings. Cross-sectional samples were prepared by embedding the covered electric wires in acrylic resin and cutting the embedded wires perpendicular to the axial direction. For evaluation of the state of the insulation covering in each sample, the corner vacancy ratio was measured for each of the four corners in each cross-sectional photograph. It was also checked whether there were any intrusion portions where the insulation covering intruded into the conductor at depths more than half of the outer diameter of the elemental wires. For evaluation of the corner vacancy ratio, the total area (A) of the out-of-conductor vacancy was measured as the area of the region between the outer circumference of the conductor and the inner surface of the insulation covering in each cross-sectional photograph. Then, the covered electric wire in the photograph was divided into eight divided regions (i.e., four equal parts in the width direction and two equal parts in the height direction), and the area (Ac) of the out-of-conductor vacancy was measured for each of the four corner divided regions. For each of the four corners, the corner vacancy ratio was calculated as Ac/A×100%.

### (Evaluation of Flame Retardancy)

Flame retardancy of the covered electric wires of Samples 1 to 5 was evaluated by conducting a combustion test. Specifically, each covered electric wire was cut into a 30 cm length and held horizontally. Then, a flame with a 35-mm long reducing flame was brought into contact with the covered electric wire at the center of the wire. It was confirmed that the insulation covering caught fire within 30 seconds after the flame contact. The flame was removed from the covered electric wire after the wire caught the fire. The period of time from the flame removal until self-extinction of the fire (i.e., the flame extinction time) was measured. The test was conducted in two test methods: one where the wire was exposed to the flame on its flat surface (i.e., the surface along the width direction), and another where the wire was exposed to the flame on its edge surface (i.e., the surface along the height direction). If the flame extinction time was shorter than 70 seconds in both test methods, the wire was evaluated as having high flame retardancy (A). On the other hand, if the flame extinction time was 70 seconds or longer in at least one of the two test methods, the wire was evaluated as having low flame retardancy (B).

### (Evaluation of Ease of Removal of Insulation Covering)

The ease of removal of the insulation covering was evaluated for each of the covered electric wires of Samples 1 to 5. Specifically, by a peeling machine with four blades set in the top, bottom, left, and right directions, a 1.0-mm deep cut was made on the covered electric wire at a position 20 mm apart from the end of the wire, and the insulation covering was then pulled out toward the end of the wire. If no remnant of the insulation covering or loosening of the elemental wires was observed after the pulling-out of the insulation covering, the covered electric wire was evaluated as having a high level of ease of removal of the insulation (i.e., level A). On the other hand, if at least one of remnants of the insulation covering and loosening of the elemental wires was observed, the covered electric wire was evaluated as having a low level of ease of removal of the insulation (i.e., level B).

### [Results of Examination]

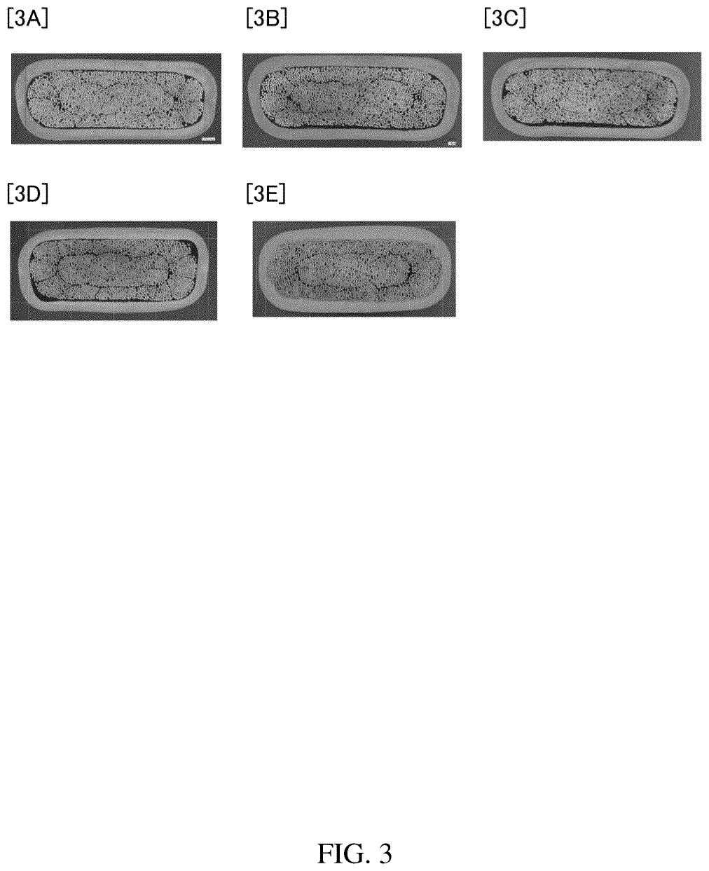

FIGS. 3A to 3E show cross-sectional photographs of Samples 1 to 5, respectively. Table 1 below shows the corner vacancy ratios in the four corner divided regions, the presence or absence of intrusion portions, and the evaluation results of the flame retardancy and ease of removal of insulation coverings. The corner vacancy ratios for Corners 1, 2, 3, and 4 correspond to those in the top left, top right, bottom right, and bottom left corner divided regions in the cross-sectional photographs, respectively.

TABLE 1

| | | Sample 1 | Sample 2 | Sample 3 | Sample 4 | Sample 5 |
|---|---|---|---|---|---|---|
| Corner | Coner 1 | 14.0 | 11.5 | 12.0 | 9.8 | 6.8 |
| Vacancy | Coner 2 | 14.3 | 8.7 | 5.6 | 22.6 | 18.9 |
| Ratio [%] | Coner 3 | 14.9 | 16.3 | 13.7 | 9.6 | 13.9 |
| | Coner 4 | 15.0 | 15.1 | 11.2 | 25.5 | 11.1 |

| | | | | | |
|---|---|---|---|---|---|
| Presence of | No | No | No | No | Yes |
| Intrusion Portions | | | | | |
| Flame Retardancy | A | A | A | B | A |
| Ease of Removal of | A | A | A | A | B |
| Insulation Covering | | | | | |

A comparison of FIGS. 3A to 3E shows that in Sample 5 in FIG. 3E, the insulation covering is in close contact with the conductor over almost the entire inner surface, whereas in Samples 1 to 4 in FIGS. 3A to 3D, out-of-conductor vacancies are clearly formed between the conductors and the insulation coverings. Furthermore, a comparison of Samples 1 to 4 shows that in Samples 1 to 3, the out-of-conductor vacancies are evenly distributed along the outer circumferences of the conductors, with no significant uneven distribution at the corners, whereas in Sample 4, the out-of-conductor vacancy is unevenly distributed at the corners, particularly at the top right and bottom left corners.

These tendencies observed in the cross-sectional photographs are further clarified by the evaluation results of the states of the insulation coverings presented in Table 1. The evaluation results for the presence or absence of intrusion portions in the insulation coverings show that Samples 1 to 4 have no intrusion portions, whereas Sample 5 has intrusion portions. Furthermore, in Samples 1 to 3, the corner vacancy ratios are less than 20% at all four corners, whereas in Sample 4, the corner vacancy ratios exceed 20% at Corners 2 and 4 (corresponding to the top right and bottom left corners, respectively).

The evaluation results of the ease of removal of the insulation coverings in Table 1 show that Sample 5 has a low level of ease of removal, whereas Samples 1 to 4 have high levels of ease of removal. This result indicates that the ease of removal of the insulation covering can be improved by excluding the intrusion portions from the insulation covering. The evaluation results of the flame retardancy show that Sample 4 has low flame retardancy, whereas Samples 1 to 3 have high flame retardancy. This result indicates that high flame retardancy can be achieved by limiting the corner vacancy ratio to lower than 20% in all four corners. These results of the investigation reveal that a covered electric wire with a conductor having a flat cross-section excels in both flame retardancy and ease of removal of the insulation covering by limiting the corner vacancy ratio to less than 20% for each of the four corners and by excluding intrusion portions from the insulation covering.

The foregoing description has been presented for a detailed illustration of the embodiments of the present disclosure; however, the present invention is not limited by the above-described embodiments, and modifications and variations are possible as long as they do not deviate from the principles of the present invention.

### DESCRIPTION OF REFERENCE NUMERALS

1, 9, and 9′ Covered electric wire
10 Conductor
15 Elemental wire
20 Insulation covering
I Intrusion portion
Rc Corner divided region
V Out-of-conductor vacancy
d Intrusion depth
h Height of conductor
w Width of conductor

1-7. (canceled)

8. A covered electric wire, comprising:
a conductor comprising a plurality of elemental wires twisted together; and
an insulation covering that covers the conductor,
wherein the covered electric wire comprises a flat portion in which the conductor has a flat shape elongated in a width direction in a cross-section perpendicular to an axial direction of the covered electric wire, and the covered electric wire has the following features in the cross-section of the flat portion:
the covered electric wire comprises an out-of-conductor vacancy provided as a vacancy between the conductor and the insulation covering;
the conductor comprises, in the cross-section:
edges that are flat portions along the width direction and a height direction perpendicular to the width direction; and
corners that correspond to junctions between the edges along the width direction and the edges along the height direction;
when the cross-section is divided into four equal parts in the width direction and two equal parts in the height direction to form eight divided regions, an area of the out-of-conductor vacancy in each of four corner divided regions, each containing one of the four corners, among the eight divided regions accounts for less than 20% of a total area of the vacancy in the cross-section; and
the insulation covering has no portion intruding into the conductor at a depth more than half of an outer diameter of the elemental wires.

9. The covered electric wire according to claim 8, wherein the conductor has a flatness ratio of 5 or less in the cross-section of the flat portion, where the flatness ratio is evaluated as w/h, with w and h representing the lengths of the conductor along the width and height directions, respectively.

10. The covered electric wire according to claim 8, wherein, in the cross-section of the flat portion, the area of the out-of-conductor vacancy in each of the four corner divided regions accounts for 5% or more of the total area of the vacancy in the cross-section.

11. The covered electric wire according to claim 8, wherein, in the cross-section of the flat portion, the out-of-conductor vacancy is distributed over entire areas between the conductor and the insulation covering in four divided regions other than the corner divided regions among the eight divided regions.

12. The covered electric wire according to claim 8, wherein the area of the out-of-conductor vacancy in at least one of the four corner divided regions accounts for less than 10% of the total area of the vacancy in the cross-section.

13. The covered electric wire according to claim 12, wherein the area of the out-of-conductor vacancy in at least one other of the four corner divided regions accounts for 10% or more of the total area of the vacancy in the cross-section.

14. The covered electric wire according to claim 8, wherein the insulation covering has larger thicknesses at the corners than at the edges.

15. A wiring harness, comprising the covered electric wire according to claim 8.
